(19) United States
(12) Patent Application Publication
(10) Pub. No.: US 2012/0106505 A1
(43) Pub. Date: May 3, 2012

(54) Method For Enhancing Handoff Between Media Gateways And Media Gateway Controller

(76) Inventors: Thulasidoss Rameshwaran, Tamilnadi (IN); Ramadoss Kumar, Tamilnadi (IN); Andreas Lehmann, Tamilnadi (IN)

(21) Appl. No.: 12/227,020

(22) PCT Filed: Nov. 26, 2007
(86) PCT No.: PCT/IB2007/004370

§ 371 Date: Jan. 17, 2012

(51) Int. Cl. H04W 36/00

(52) U.S. Cl. 370/331

(57) ABSTRACT

Handoff of a media gateway (MG) from a primary media gateway controller (MGC) to a secondary MGC includes the primary MGC identifying a secondary MGC for performing MG handoff; and the primary MGC identifying a group of MGs, including at least one MG, to be handed off to the secondary MGC. If the group of MGs includes more than one MG, the following sequence is repeated—the primary MGC selecting a MG in the group; the primary MGC sending a handoff request to the MG, including identification of the secondary MGC; and the primary MGC standing by for a predetermined duration depending upon configuration of the MG.

### FIELD OF THE INVENTION

The invention relates to the control of media gateways in communication networks, and more specifically to a method for performing handoff between media gateways (MG) and media gateway controllers (MGC).

### BACKGROUND OF THE INVENTION

Gateways were introduced to allow communication networks of different kinds (i.e. having different communication protocols) to intercommunicate. Basically, a gateway ensures signaling, initiation, management and termination of communications between networks of different kinds, such as a mobile network and a Public Switched Telephone Network (PSTN). It also achieves signal conversion between the networks.

First based on the H.323 protocol proposed by the International Telecommunication Union (ITU), gateways used to be complex entities unable to be distantly controlled. Media Gateway Control Protocol (MGCP) and MEGACO (MEdia GAteway COntrol), also called H.248, respectively defined in IETF standards RFC 3435 and RFC 3525, obsolete the H.323 by introducing a call agent or Media Gateway Controller (MGC) (also called SoftSwitch according to a common though unofficial terminology) which, together with a MG, forms a distributed system (of the server/client type) that performs the conversion of media signals between two different and yet interconnected networks, in order for messages sent from a first user terminal (endpoint) to be delivered to a second (distant) user terminal (other endpoint).

The MGC controls at least one MG (and usually a set of MGs). It concentrates the network “intelligence” and performs the decision making (see G. Pujolle, Les Réseaux, ed. 2008). The MGC uses MGCP/H.248 to tell the Media Gateway which events should be reported, how endpoints should be interconnected, and which signals should be played on endpoints. The MGC may also audit the current state of endpoints on a MG. In return, the MG uses MGCP to report events to the MGC.

The MG main task is to ensure that data are delivered in a coherent manner. In order to achieve this task, the MG performs signal conversion, support adaptation, data compression, signaling conversion, multiplexing and data packeting.

Typically, a MG is configured with a list of MGCs from which it may accept distant programming (ordinarily the list comprises one or two MGCs). In practice, even if a MG accepts control from two or more MGC, only one of them (called primary MGC) is used to control all endpoints on the MG at the same time, whereas the other MGC(s) (called secondary or backup MGC(s)) is/are available only to provide redundancy in the event the primary MGC fails or shall be switched off for maintenance.

In the event of such a failure it is the backup MGC's responsibility to reprogram the MG so that it comes under the control of the backup MGC. Such a procedure is called handoff. More specifically, the failing MGC (which is presumably shutting down) informs its controlled MGs of the handoff through a H.248 service change command. For more details about the H.248 protocol, one can refer to the document (“TISPAN NGN Release 2; H.248 Non-Call Related Procedures and Management System Interaction; Draft ETSI TR 183 025”, Vol. TISPAN, no V2.1.0, 1 Nov. 2007) which specifies main functions governed by H.248 protocol.

As a result of the message the MGs register themselves with the secondary (or backup) MGC which in turn audits the terminations (i.e. the connections with endpoints) to determine their states (e.g. Offhook, Onhook, Ringing or In call). More details regarding this procedure may be found in Salman A. Baset and Zahid Anwar, Megaco and SIP Internetworking, International SIP Conference, France, January 2003. Reference may also be made to Korean patent application No. KR 2004 0044248 (LG ELECTRONICS), in which a handoff function of the MGC is processed using a Realm-specific Internet Protocol (RSIP) message sent both to a MG and a MGC.

In partial failure, or for manual maintenance reasons, a MGC may wish to direct the controlled MGs toward a different MGC, which generally belongs to the list of default backup MGC(s) programmed in the MGs. In order to achieve redirection, the primary MGC sends a suitable message to the MG including designation of the replacing MGC. The MG shall then send a message to the designated MGC, including e.g. the reason for handoff. If the MG fails to get a reply from the designated MGC, the MG shall behave as if its MGC has failed, and start contacting the predetermined secondary (backup) MGCs.

It has come to the inventors' mind that one critical issue involved in a handoff process is the amount of load put on the designated MGC. In case the MG at stake is a big MG, including numerous terminations, the time needed for this MG to get registered with the designated MGC (including all its terminations) is significant, since all terminations have to be audited, as stated hereinbefore. Accordingly, if another MG requests registration with the same designated MGC, probability is high that the designated MGC will be soon overloaded. The inventors have calculated that the load of the designated MGC is an exponential function of the number of MGs simultaneously (or almost simultaneously) requesting registration. In practice, the amount of load put on the designated MGC depends upon the primary MGC, which actually triggers the respective MGs to issue handoff requests to the designated MGC.

Solutions for limiting the load put on the designated MGC exist. In a first solution, an operator performs MG handoff in a sequential way, i.e. handoff is issued for one MG only after the previous MG has been successfully registered with the designated MGC. In a second solution, an operator performs MG handoff in parallel, where different MGs send sending handoff requests at the same time to different designated MGCs. In a third solution, an operator performs MG handoff in an unstructured manner, i.e. each MG is addressed sequentially to a different designated MGC. All three solutions are time consuming and it is therefore clear they are inappropriate for large scale handoff processes.

### SUMMARY OF THE INVENTION

It is an object of the invention to provide a reliable and time-saving solution for performing MG/MGC handoff.

The proposed invention therefore provides, according to one object, a Method for performing handoff of a media gateway (MG) from a primary media gateway controller (MGC) to a secondary MGC, said method including the steps of:
a) the primary MGC identifying a secondary MGC for performing MG handoff;
b) the primary MGC identifying a group of MGs, including at least one MG, to be handed off to the secondary MGC;
c) if the group of MGs includes more than one MG, repeating the following sequence:
   c.1) the primary MGC selecting a MG in the group;
   c.2) the primary MGC sending a handoff request to said MG, including identification of the secondary MGC;
   c.2) the primary MGC standing by for a predetermined duration depending upon configuration of said MG.

### BRIEF DESCRIPTION OF THE DRAWINGS

The above and other objects and advantages of the invention will become apparent from the detailed description of preferred embodiments, considered in conjunction with the accompanying drawings.

In the drawings:

FIG. 1 is a schematic view illustrating handoff of a set of MGs from a primary MGC to a secondary MGC.

FIG. 2 to FIG. 4 are flow charts illustrating steps of a handoff method according to the present invention.

### DESCRIPTION OF PREFERRED EMBODIMENTS

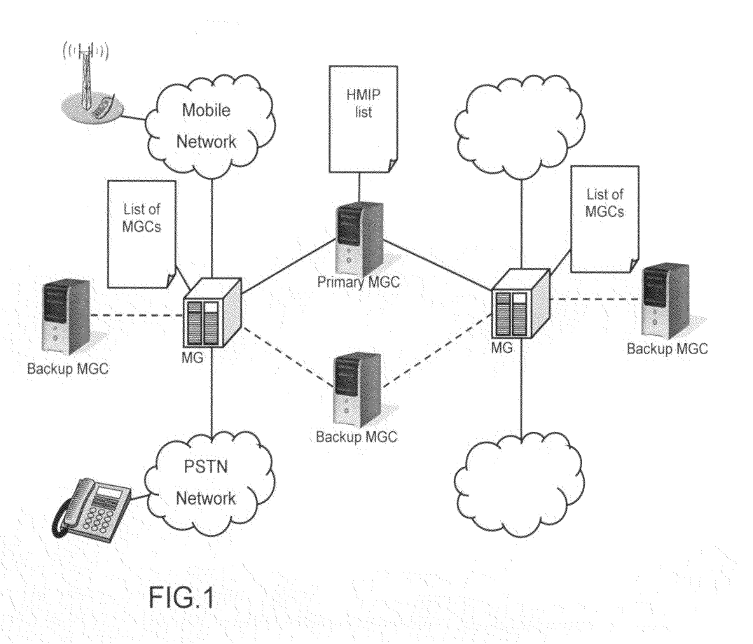

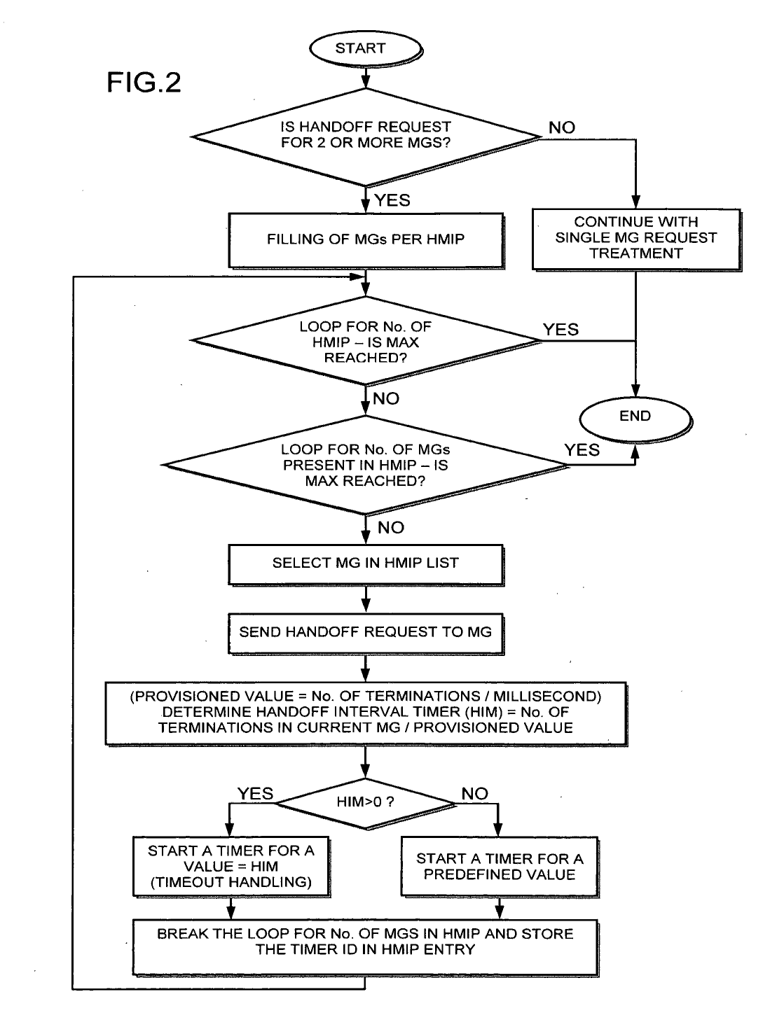

Referring now to FIG. 1, there is shown an MGCP/H.248 architecture including a set of MGs interconnecting different types of communication networks, such as respectively a PSTN and a mobile network, and controlled by a same MGC, called primary MGC. Each MG is configured to perform protocol conversion in order to allow communication between terminals linked to the different networks, such as a PSTN telephone and a mobile phone. Each MG is therefore equipped with a predetermined number of terminations, equal to the number of terminals it is capable of interconnecting.

Each MG is programmed with a list of secondary MGCs including at least one MGC different from the primary MGC and which may take control over the MG in place of the primary MGC, e.g. in case of failure or maintenance thereof.

The MGs controlled by the primary MGC are identified in a MG list programmed in the MGC. For each MG, the number of terminations is memorized together with the corresponding MG ID.

Whenever the primary MGC is about to loose connection with its controlled MGs, e.g. in case of failure or programmed maintenance thereof, each MG needs to be allocated to a different MGC, called secondary or backup MGC, in order to maintain the communications performed by the MG. Each MG is programmed with a list of MGCs, including the primary MGC, and one or more backup MGCs. Transfer of control of a same MG from a primary MGC to a backup MGC is called handoff.

Basically, in order to perform handoff of a MG from the primary MGC to a backup MGC, the following steps are provided.

The primary MGC identifies a backup MGC to which MGs must be handed off. This backup MGC is called the designated backup MGC.

The primary MGC also identifies a group of controlled MGs to hand off to the designated MGC. In order to achieve this step, the primary MGC checks the lists of backup MGCs and selects the MGs the lists of which include the designated MGC.

If the group of MGs includes only one MG, the primary MGC sends the MG a handoff request, including identification of the designated MGC. The MG then sends the designated MGC a registration request. The designated MGC registers the requesting MG by auditing the terminations and subsequently taking control over the MG.

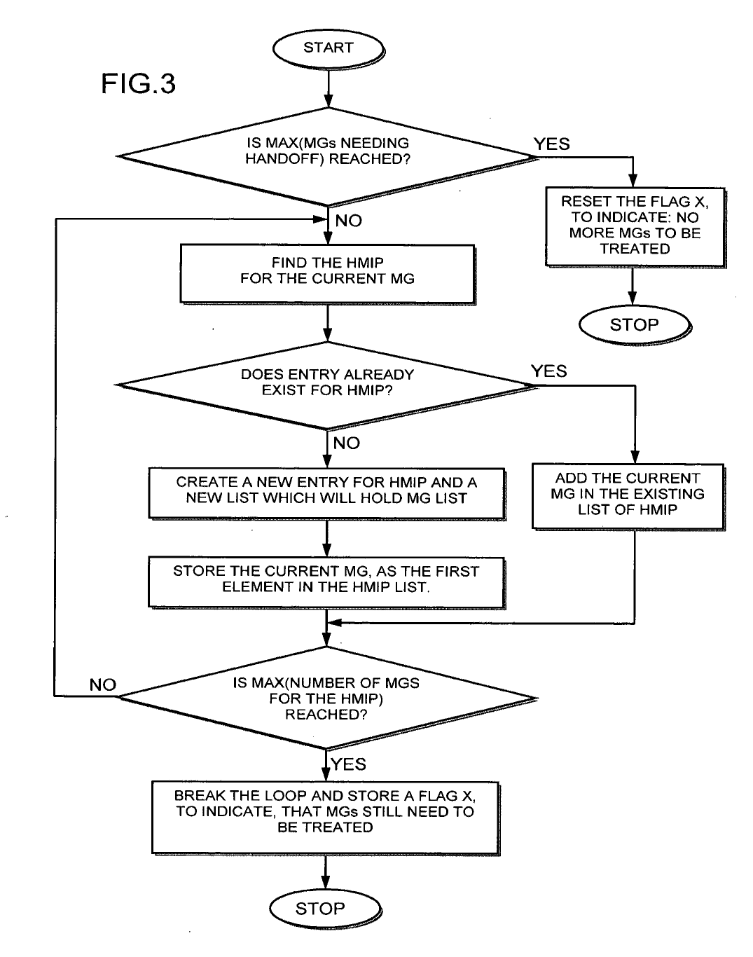

If the group of MGs includes more than two MGs, then the primary MGC creates an MG list including MGs to hand off to the same designated MGC. In a header field of the MG, identification of the designated MGC may be provided through its IP address or HMIP (Headoff MGC IP). The list is filled by the primary MGC according to a HMIP filling procedure illustrated on FIG. 3, which is now described.

Each MG to hand off is treated in a sequential mode.

In a first step, the primary MGC retrieves the HMIP of the MGC designated for the current MG. If the primary MGC already has an entry for the HMIP, then the current MG is added to the corresponding HMIP list.

On the contrary, if the MGC has no entry for the HMIP, it creates a new entry for the HMIP together with a (initially void) list of MGs to be handed off to the corresponding designated MGC.

The primary MGC then adds the current MG to the HMIP list, as the first element therein.

This sequence is repeated in loop for all MGs to be handed off until:
either a predetermined maximum number of MGs allowed in the HMIP list is reached,
or the maximum number of MGs needing handoff is reached.

In the first case, the loop is broken and the MGC issues:
a flag X (true) indicating that MGs still need to be treated despite fulfillment of the HMIP list,
an index to indicate from which MG the re-filling of the HMIP list should start.

In the second case, the MGC resets the flag X (false) to indicate that no more MG need to be treated.

Once the HMIP procedure is over, the primary MGC proceeds with handoff treatment in loop for each MG in each HMIP, until a predetermined maximum number of HMIPs is reached and until, where applicable, the maximum number of MGs present in an HMIP list is reached.

After the MGC has selected a MG in the HMIP list (i.e. the one standing on top of the list), the primary MGC sends the MG a handoff request, including identification of the designated MGC. The MG then sends the designated MGC a registration request. Having received such a request, the designated MGC registers the requesting MG by auditing the terminations and subsequently taking control over the MG. as such a registration procedure takes time, the next MG in the HMIP list is not treated immediately by the primary MGC, which stands by for a certain duration, called Handoff Interval tiMer (HIM) which is function of (e.g. proportionate to) the number of terminations of the current MG.

It is assumed that the registration frequency, i.e. the number of terminations a MG can register with an MGC per unit of time, or NV (Network Value) is pre-provisioned and stored in the primary MGC. In one embodiment, NV=1000 ms⁻¹ (terminations per milliseconds).

The primary MGC retrieves the number T of terminations of the current MG and calculates a HIM as follows:

$$HIM = \frac{T}{NV}$$

For example, for a MG having 150,000 terminations HIM, and assuming that NV is set to 1000 ms⁻¹, HIM=150 ms.

If HIM>0, the primary MGC starts a timer equal to HIM, during which the MGC stands by—which means the handoff treatment loop is broken for the other MGs present in the HMIP list. The primary MGC stores a timer ID in a HMIP entry.

If HIM=0, meaning the MG has no active termination (T=0), the primary starts a timer for a predefined value corresponding to an assumed time of registration of such an MG in the designated MGC.

Accordingly, the primary MGC introduced a throttle mechanism in the handoff procedure, whereby time is left to the designated MGC to properly register the current MG (with proper termination audit) before the next MG in the HMIP list is requested to hand off.

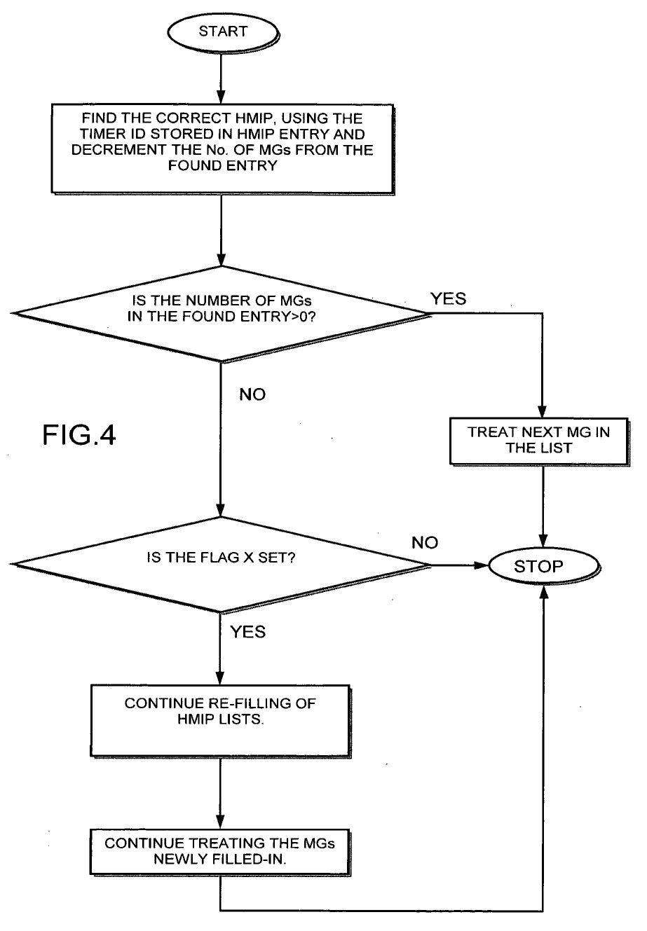

Once the timer has expired, the HMIP uses the stored timer ID to retrieve the correct HMIP using the corresponding address in order to proceed with the MG handoff treatment (FIG. 4). The number of MGs present in the HMIP list is decremented to denote that a MG belonging to this list has been treated successfully.

As long as there are MGs remaining in the in the HMIP (in other words the number of MGs in the list does not equal 0), the MGC proceeds with handoff treatment with the MG which is next in the list.

If there are no more MGs in the HMIP list (in other words the number of MGs in the list equals 0), the MGC checks state of flag X. If flag X is not set (false), it means that all MGs of the HMIP list have been duly treated for handoff. If flag X is set (true), then HMIP list is re-filled with MGs to be handed off, and handoff treatment of the newly filled-in MGs is resumed.

The handoff method disclosed hereinbefore may be applied to several cases.

It may be first applied to MGC failure, e.g. due to unexpected network load. In such a case the MGs shall failover to the designated MGC. As soon as the primary MGC is back in traffic again, the MGs shall be brought back to hits control via the proposed handoff method.

The method may also be applied to primary MGC maintenance, where traffic managed by the primary MGC needs to be routed to a designated MGC. Once maintenance is over and primary MGC is back in traffic again, the MGs shall be brought back to hits control via the proposed handoff method.

During (possibly planned) traffic overload, the load on the primary MGC may be distributed (and therefore reduced) to a designated backup MGC according to the proposed handoff method. Handed off MGs may be brought back to the control of the primary MGC according to the same handoff method.

Accordingly, the proposed method allows smooth and sequential handoff of MGs. Load can be reduced on a primary and/or backup designated MGC through wise MG distribution. Traffic handling is not affected.

In practice, the steps of the proposed handoff method are programmed in code sections within a computer program product implemented on a computer processing unit the primary PGC is equipped with, configure to control a set of MGs.

1. Method for performing handoff of a media gateway (MG) from a primary media gateway controller (MGC) to a secondary MGC, said method comprising:
identifying, by said primary MGC, a secondary MGC for performing MG handoff;
identifying, by said primary MGC, a group of MGs, including at least one MG, to be handed off to the secondary MGC;
if the group of MGs includes more than one MG, repeating the following sequence,
selecting, by said primary MGC, a MG in the group;
sending, by said primary MGC, a handoff request to said selected MG, including identification of the secondary MGC;
standing by, at said primary MGC, for a duration depending upon configuration of said MG.

2. Method according to claim 1, wherein said duration is function of the number of terminations of the MG.

3. Method according to claim 2, wherein said duration is proportionate to the number of terminations of the MG.

4. Method according to claim 3, wherein said duration is calculated by the rate of the number of terminations of the selected MG, to the number of terminations which the secondary MGC is capable of handling per unit of time.

5. Method according to claim 1, further comprising:
sorting MGs in lists wherein MGs to be handed off to a same secondary MGC are memorized.

6. Method according to claim 5, wherein criteria for creation and/or filling of each list include an IP address of the corresponding secondary MGC.

7. Computer program product implemented on a computer processing unit, said program including code sections for performing the operations of a method according to claim 1.

8. Computer processing unit implemented with a computer program product according to claim 7.

9. (canceled)

10. A multimedia gateway controller, comprising:
a processing unit, the processing unit implemented with a computer program for performing a handoff method according to claim 1.
